(19) United States
(12) Patent Application Publication
(10) Pub. No.: US 2004/0102545 A1
(43) Pub. Date: May 27, 2004

(54) Aqueous based vinyl acetate based emulsions with epoxy/amine for improved wet adhesion in paints

(76) Inventors: Lloyd Mahlon Robeson, Macungie, PA (US); Lori Anderson Vratsanos, Breinigsville, PA (US); Susan Ann Miller, Orefield, PA (US)

Correspondence Address: AIR PRODUCTS AND CHEMICALS, INC., PATENT DEPARTMENT, 7201 HAMILTON BOULEVARD, ALLENTOWN, PA, 181951501

(21) Appl. No.: 10/304,881

(22) Filed: Nov. 25, 2002

(51) Int. Cl. C08L 63/00

(52) U.S. Cl. 523/412

(57) ABSTRACT

This invention relates to an improvement in water-based paint formulations comprised of a pigment grind and a vinyl acetate based or acrylic based polymeric emulsion; wherein the improvement resides in incorporating an epoxy resin and amine curative into said water-based paint. The invention also relates to painted surfaces having the improved water-based paint formulation applied thereto.

### BACKGROUND OF THE INVENTION

Water based paints have been widely used as an alternative to solvent based paints in both interior and exterior applications. Polymer emulsions based on vinyl acetate (e.g. vinyl acetate-ethylene and vinyl-acrylic copolymers) are typical of those commonly employed in interior and architectural paint applications. They offer many attributes for these applications including the ability to be applied as a water-borne system, ease of compounding with typical paint additives, high scrub resistance, and low cost. One of the properties lacking in water based paints is that of wet adhesion. Wet adhesion refers to the ability of a paint film to maintain good adhesion in the presence of a high humidity environment or with water immersion/washing. A particular problem is that of adherence at high humidity to a previously painted surface, e.g., those painted with an alkyd type coating.

One approach to improving the wet adhesion of paints formulated with water-based vinyl acetate and acrylic copolymer emulsions has been through the use of wet adhesion promoting monomers in the polymerization process. Representative patents and articles illustrating the use of wet adhesion promoting monomers are as follows:

U.S. Pat. No. 4,302,375 discloses the emulsion polymerization of a diallylic urea monomer with vinyl acetate and ethylene in an effort to provide wet adhesion to vinyl acetate based coating emulsions.

U.S. Pat. No. 4,340,743 and U.S. Pat. No. 4,429,095 disclose the use of cyclic alkylene ureas as wet adhesion promoting monomers for polymerization into vinyl acetate and vinyl acrylic systems to improve wet adhesion in paint formulations.

U.S. Pat. No. 4,783,539 disclose the use of methacryloxy containing monomers as wet adhesion promoters for emulsion based paints.

Another series of patents unrelated to paints disclose a combination of waterborne epoxy resins including amine curatives with vinyl and acrylic polymer emulsions to yield a crosslinked network.

JP 63126981 (1988) (abstract) discloses adhesives prepared from emulsion adhesives and epoxy resins. An example is noted where a 50% solids emulsion of 10/60/30 acrylonitrile/ethyl acrylate/vinyl acetate terpolymer and a 50% solids emulsion of a bisphenol A-epichlorohydrin copolymer (epoxy) and a polyamine were mixed.

JP 48092451 (1973) (abstract) discloses emulsion blends of an epoxy resin emulsion and a vinyl polymer emulsion with an epoxy curing agent for utility as an adhesive or coating. The epoxy utilized is emulsified prior to addition to the poly(vinyl acetate) emulsion.

U.S. Pat. No. 6,235,811 discloses hybrid polymeric compositions comprised of an epoxy resin and a vinyl acetate polymer emulsion including isophoronediamine as a curing agent. The product has good physical properties and is used in the production of polymeric sheets, films, protective coatings, caulking, sealants adhesives, and the like. The epoxy resin is emulsified into the vinyl acetate polymer emulsion in an amount from 5 to 70, preferably at least 20 parts by weight per 100 parts by weight of the vinyl acetate polymer and epoxy resin combined.

### BRIEF SUMMARY OF THE INVENTION

This invention relates to an improvement in water-based paint formulations comprised of a pigment grind and a vinyl acetate based or acrylic based polymeric emulsion. It also resides in painted surfaces having the water-based paint formulation applied thereto. The improvement in the water-based paint formulations resides in the combination of an epoxy resin with the vinyl acetate or acrylic emulsion. Significant advantages can be achieved with the water-based paint formations of this invention and they include:

an ability to improve the wet adhesion properties of the paint formulation;

an ability to apply the water-based paint formulation to painted surfaces and maintain adhesion, particularly under conditions of high humidity;

an ability to apply a water-based paint to surfaces painted with an alkyd resin and maintaining adhesion under high humidity; and,

an ability to formulate stable one-part systems comprised of epoxy/amine blends into water-borne emulsion polymers.

### DETAILED DESCRIPTION OF THE INVENTION

Water-based vinyl acetate polymeric emulsions suited for use in preparing paint formulations of this invention can be produced by emulsion polymerization and the technology for polymerization is well-known and has been commercially practiced for over four decades. These emulsions are prepared by the addition of vinyl acetate and other monomers to water containing a surfactant and/or protective colloid system. The prior art cited herein is representative.

The surfactants which can be used in forming the water-based polymeric emulsions include anionic, non-ionic, and cationic surfactants. Generally anionic and non-ionic are preferred with non-ionic most preferred for this invention. The non-ionic surfactants include ethoxylated alkyl phenols and ethylene oxide/propylene oxide block copolymers. Protective colloids can also be employed as is or in admixtures with other surfactants. The preferred protective colloids are poly(vinyl alcohol) and hydroxyethylcellulose.

The polymerization of the vinyl acetate homopolymers and copolymers of this invention involves free radical initiated polymerization. Typical free radical initiators include organic peroxides, azo initiators (such as 2,2′-azobisisobutytronitrile), peroxysulfates and redox initiation systems. Redox initiation systems include persulfate-bisulfate, hydrogen peroxide-iron, hydroperoxide-iron, and chlorate-bisulfate systems. Specific systems include a combination of potassium, sodium or ammonium persulfate with various reducing agents such as sodium hydrogen sulfite, ascorbic acid, erythrobic acid, sodium formaldehyde sulfoxylate, and the like.

Chain transfer agents such as mercaptans and thiols can be added to control the molecular weight.

Comonomers along with the vinyl acetate monomer include C1-8 alkyl (meth)acrylates such as methyl methacrylate, ethyl methacrylate, n-butyl methacrylate, methyl acrylate, ethyl acrylate, n-butyl acrylate, and 2-ethyl hexyl acrylate; unsaturated carboxylic acids such as acrylic acid, methacrylic acid, maleic anhydride; vinyl chloride, and the like. Acrylic acid, maleic anhydride and methacrylic acid can be added to the acrylate emulsions at levels to improve the pigment dispersion but not to unduly decrease the water resistance. Additionally low amounts of monomers containing more than one polymerizable double bond can be added. These can include but are not limited to hexanediol diacrylate, tetraethylene glycol diacrylate, ethylene glycol dimethacrylate and the like. As is known, styrene and substituted styrenic monomers are to be avoided in the vinyl acetate copolymer emulsion systems.

Examples of preferred monomer systems are based upon vinyl acetate-ethylene copolymers, vinyl acetate-acrylic copolymers such as vinyl acetate/n-butyl acrylate copolymers and all acrylic systems, e.g., copolymers comprised of methyl methacrylate and butyl acrylate. The vinyl acetate-acrylic copolymers, vinyl acetate-ethylene and all acrylic copolymers have compositions such that the glass transition temperature of the dry film is between 0° C. and 25° C.

Styrene-acrylate emulsion coatings are also contemplated. The acrylate monomers can include C1-8 (meth)acrylates such as methyl methacrylate, ethyl methacrylate, n-butyl methacrylate, methyl acrylate, ethyl acrylate, n-butyl acrylate, 2-ethyl hexyl acrylate as is or in copolymerized compositions. The preferred styrene-acrylate copolymer is styrene/n-butyl acrylate. The choice of acrylate(s) in the acrylate or styrene-acrylate emulsion is made to yield a glass transition temperature such that film formation at coating temperature is achieved along with good blocking resistance. This generally requires glass transition temperatures in the range of 0 to 25° C. with a preferred range of 10 to 20° C.

A wide range of liquid epoxy resins can be incorporated in the water-based copolymer emulsions with agitation applied during addition of the epoxy resin for producing paint formulations. For more viscous epoxy resins including those which are solid at room temperature, incorporation into the water-based emulsions will require higher temperatures and may also require more vigorous agitation and can include ultrasonic agitation techniques.

The preferred epoxy resin is the diglycidyl ether of bisphenol A, as noted by the structure below:

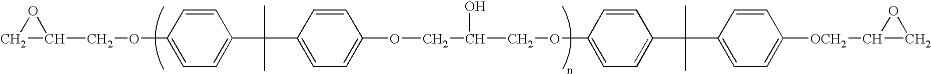

where n=0 to 5. Other variations of interest include the replacement of one or more isopropylidene group with —CH₂—, —SO₂—, or one of the structural groups noted below:

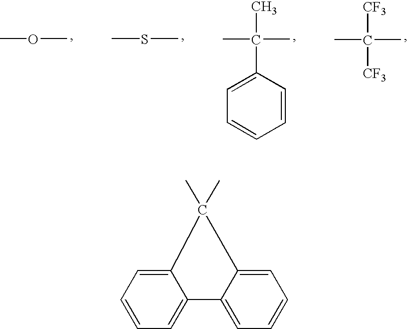

In addition to the bisphenol derived epoxies described above, epoxy phenol novolac resins, tetraglycidyl ether of tetrakis(4-hydroxyphenyl) ethane, N,N,N′,N′-tetraglycidyl-4,4′-diaminodiphenylmethane, triglycidyl isocyanurate, and triglycidyl-p-aminophenol are additional epoxy resins of interest in this invention primarily as additives up to 25 wt % based on the bisphenol derived epoxy noted above.

Aliphatic and cycloaliphatic epoxy resins are also of interest in this invention. This would include the diglycidyl ether of butane diol, 3,4-epoxycyclohexyloxirane; bis(3,4-epoxy-cyclohexylmethyl) adipate; 3′,4′-epoxycyclohexylmethyl-3,4-epoxycyclohexanecarboxylate; 2-(3′,4′-epoxycyclohexyl)-5,1″-spiro-3″,4″-epoxycyclohexane-1,3-dioxane; the diglycidyl ester of hexahydrophthalic acid, and epoxidized natural oils such as epoxidized soybean oil and epoxidized linseed oil. In preferred formulation, their addition level is desired to be <25 wt % of the epoxy derived from bisphenols noted above.

Typically, the epoxy resin is included in the water-based paint formulation in an amount of from 2 to 25 % by weight based upon the polymer solids content in the vinyl acetate, acrylate or styrene/acrylate polymer emulsion. It is surprising that such low levels of epoxy resin can result in the degree of wet adhesion that is achieved. High levels of epoxy resin tend to result in highly viscous and unstable emulsions.

A wide variety of amine curatives can be used to formulate the water-based paint formulations. These amine curatives are incorporated in substantially stoichiometric amounts based upon the epoxy resin. Examples of amines which can be used are the polyalkylene amines, e.g., diethylenetriamine, triethylenetetraamine, isophoronediamine, diamines of oligomeric poly(propylene oxide), 2-methyl-1,5-pentanediamine, polyamide polyamines, polycycloaliphatic amines, dimethylenedi(cyclohexylamine), aminoethylpiperazine, xylylenediamine, and the like.

The epoxy modified water-based polymeric emulsions of this invention can be formulated to yield interior and exterior flat, satin, semi-gloss or high gloss architectural coatings (paint) formulations having wet adhesion. The additives typically employed in such paint formulations including pigments, TiO₂, fillers including CaCO₃, talc, mica, barium sulfate, silica and the like, clays, dispersing agents such as tetrasodium pyrophosphate or soya lecithin, wetting agents, defoamers (such as acetylenic diols), plasticizers (such as dioctyl phthalate), associative thickeners for rheology control (such as non-ionic, hydrophobically-modified ethylene oxide urethane block copolymers (HEUR); ionic, hydrophobically-modified alkali soluble emulsions (HASE), and non-ionic, hydrophobically-modified hydroxyethyl cellulose (HMHEC)), waxes, colorants, antioxidants, UV stabilizers, biocides, coalescing agents (such as hexylene glycol or ethylene glycol monobutyl ether, adipic, phthalic and benzoic acid esters of propanediol, propylene glycol ether and the like), additives for pH control and alkyd or unsaturated polyester emulsions, freeze-thaw additives such as ethylene glycol and propylene glycol can also be added.

The coatings of this invention can be applied by a variety of methods; for example, spray techniques, brushed onto substrates, applied with fiber based rollers, and applied using roll coating equipment and the like. The substrates to which the coatings of this invention may be applied include wood-based, plasterboard, cement, wallpaper, previously coated surfaces, stucco, leather, plastic-based surfaces, plastic film, paper, cardboard, metal and the like. The coatings can be utilized preferably in interior applications but exterior applications can also be considered.

The following examples are provided to illustrate various embodiments of the invention and are not intended to restrict the scope thereof.

### GENERAL FORMULATION AND TEST PROCEDURES

Semi-gloss paint formulations involve initially preparing a grind paste. The grind paste employed here comprised 3.50 parts Texanol, a coalescing solvent supplied by Eastman; 8.75 parts of propylene glycol; 3.5 parts Tamol 731, a dispersant supplied by Rohm and Haas; 0.50 parts Foamaster 44 defoamer; 0.75 parts AMP95 to adjust pH; 62.50 parts TiPure R-900 titanium dioxide pigment, supplied by DuPont; 0.25 parts Kathon LX 1.5% biocide; 10 parts of water; 0.38 parts Aerosol O.T. defoamer; 0.50 parts Foamaster 44 defoamer; and 43.75 parts of Natrosol 250MR, 3% cellulosic thickener supplied by Aqualon/Hercules. (The grind paste is made in the order of addition of the compound listed, thus Foamaster 44 defoamer appears twice in the order as it is added at two separate times.) The grind paste (134.4 grams) was blended with x grams (g) of water and 105 g of the emulsion (55% solids basis); x is calculated to maintain a consistent solids for the overall formulation: e.g. 55 wt %; 17.8 g for an emulsion with 55% solids.

The samples were coated onto panels, allowed to dry and tested for gloss, reflectance, freeze/thaw resistance, scrub resistance, wet adhesion, and block resistance.

The preparation of the coating emulsions noted in the examples involved the following procedure:

1.) The grind paste (134.4 grams) was weighed into a 500 ml beaker.

2.) The grind paste was slowly mixed with a mechanical stirrer at 100 rpm.

3.) Water to be added was slowly introduced into the beaker while gradually increasing stirrer speed to 200 rpm.

4.) The emulsion (emulsion blend) (105 grams at 55% solids) was added to the beaker and the rpm gradually increased to 360 rpm. In forming the emulsion blend epoxy was added to the vinyl acetate based emulsion by slow pouring the epoxy liquid into a vortex of the emulsion being stirred with a propeller blade stirrer. The epoxy liquid was added either at room temperature or after being heated up to 60° C. After the epoxy was well mixed (generally one to two minutes after the epoxy was added), the amine curative was added. In order to maintain constant solids, the amine curative was diluted with water before addition. The dilution also helps prevent premature coagulation due to the very localized high pH which will occur with amine addition to the emulsion.

5.) Mix for an additional 10 minutes.

6.) Approximately ½-inch (1.27 cm) was poured into a 2-oz. (59 ml) plastic jar for Freeze-Thaw testing.

7.) The rest of the paint mixture was poured into an 8-oz. (237 ml) plastic container.

8.) Viscosities of the paint mixture were taken 24-48 hours after the paints were prepared using a Brookfield viscometer, Model KU-1. The viscosity was reported in Krebs units (KU).

Test Procedures

Freeze-Thaw is a test simply allowing the ½-inches (1.27 cm)of paint in the 2 oz. (59 ml) jar to go through up to 5 freezing and thawing cycles, and checking after each cycle with a wooden tongue depressor if the paint mixture can still be stirred and is smooth-looking.

Scrub testing was measured using ASTM Method D-2486-95.

Blocking resistance was measured using the following procedure: 1.) Coating was drawn down on white, sealed Leneta paper, 3 mil film caster, in controlled temperature and humidity (CTH) room; 2.) After appropriate drying time, painted area of draw-down was cut into 1.5-inch (3.8 cm)×1.5-inch squares; 3.) Painted sides were placed together to form a blocking pair; 4.) Two to three pairs of each sample were prepared for each test and pairs of the same time test were stacked together (up to 6 pairs); 5.) The stacked pairs were topped with a No. 8 rubber stopper, small diameter down, then a 100 g, a 500 g or a 1000 g weight; 6.) After a predetermined time, each pair was separated from a corner; 7.) The sounds produced were listened for and paint separation and/or tearing was noted; 8.) A blocking grade number was assigned to the sample, based on following ASTM Block Resistance Ratings: 0=75 to 100% seal; 1=50 to 75% seal; 2=25 to 50% seal; 3=5 to 25% seal; 4=very tacky; no seal; 5=moderate tack; 6=slight tack; 7=very slight to slight tack; 8=very slight tack; 9=trace tack; 10=no tack. In addition to the blocking test procedure noted above; ASTM Method D 4946-89 (reapproved 1994) was also employed for additional block resistance evaluations.

The optical test is a test measuring drawdowns of the paint composition on opacity display charts using a 3 mil film caster. Films were dried in the CTH room in a horizontal position for at least 24 hours. Films were read with a gloss meter at a minimum of 3 locations for each optical category and an average was taken. ASTM D 2805-96a and ASTM D 523-89 (reapproved 1994) procedures were followed for the reflectance, contrast ratio and gloss data reported for the various experimental compositions noted in the following examples.

Wet adhesion is a test to determine adherence to a surface coated with an alkyd coating. It is as follows: Black scrub test panels were coated with a 3 mil drawdown of an alkyd glossy green enamel. These panels were allowed to cure for at least four weeks and then cut in half; two samples were tested on each half. The half alkyd panel was placed on a vacuum drawdown plate and, the paint samples to be tested were coated using a 3 mil drawdown. The samples were allowed to dry overnight (18-24 hrs) in a CTH room. The dried panel was placed on a glass plate so that the paint film could be etched. A sharp razor blade and ruler were used to make a grid of 5-inch (12.7 cm)×5¼-inch (13.34 cm) squares in the middle of the panel, preferably where there were no imperfections in the film, cutting through the coating to the substrate. The etched panel was soaked for 30 minutes in a pan of deionized water. The panel was then placed on a glass plate and put in the Washability and Wear Tester (Paul N. Gardner Company, Inc.) This same machine was used for scrub testing. Ten ml of Dl water was placed on the film, a large spoonful of ASTM scrub media was placed on a nylon scrub brush, the brush was placed in the machine and the panel was scrubbed for 100 cycles. Wet adhesion was reported based on the percentage of the 25 squares that were not scrubbed off.

### EXAMPLE 1

### WET ADHESION OF VINYL ACETATE/ETHYLENE BASED PAINT

A first sample of AIRFLEX® 809 vinyl acetate/ethylene (VAE) polymer emulsion was prepared with 20 wt % epoxy added (solids basis) and a stoichiometric amount of IPDA (isophoronediamine). This sample was tested using the semi-gloss protocol described above.

A portion of the AIRFLEX 809 VAE polymer/epoxy/IPDA sample described above was diluted with VINAC® 884 poly(vinyl acetate) (PVAc) emulsion at two different levels and tested using the semi-gloss protocol. The results are shown in Table 1.

TABLE 1

| | AIRFLEX 809 | AIRFLEX 809 | AIRFLEX 809 |
|---|---|---|---|
| | VAE | VAE | VAE |
| | polymer/Epon | polymer/VINAC | polymer/VINAC |
| Blend | 828 Epoxy | 884 PVAc/Epoxy | 884 PVAc/Epoxy |
| Ratio (by wt. | 80/20 | 60/25/15 | 48/40/15 |
| solids) | | | |
| Viscosity: 24 | 97 | 99 | 94 |
| hr KU | | | |
| 20 Gloss | 3.9 | 5.5 | 3.5 |
| 60 Gloss | 32.1 | 37.9 | 26.9 |
| Reflectance | 94.4 | 94.3 | 94.6 |
| Contrast Ratio | 0.982 | 0.983 | 0.983 |
| Freeze/Thaw (# | fail (1) | fail (1) | fail (1) |
| cycles) | | | |
| Reflectance/Black | 92.7 | 92.7 | 93 |
| Scrub resistance | 4375 | 2399 | 2284 |
| (cycles) | | | |
| Blocking | | | |
| Dry time 1.5 hr; | 7, 6, 7 | 7, 7, 8 | 8, 7, 8 |
| 100 g | | | |
| Dry time 1.5 hr; | 5, 5, 5 | 7, 7, 7 | 7, 8, 7 |
| 500 g | | | |
| ASTM METHOD | | | |
| (1 kg) | | | |
| Dry time: 1 hr | 3, 3, 3 | 7, 7, 7 | 7, 7, 8 |
| Dry time: 4 hrs. | 3, 3, 3 | 6, 5, 5 | 6, 6, 6 |
| Dry time: 24 hrs | 3, 3, 3 | 3, 3, 3 | 3, 3, 3 |
| Wet Adhesion | 100% | 100% | 100% |

Stoichiometric addition of isophoronediamine based on included epoxy.

The data in the above table show that excellent wet adhesion was achieved for the epoxy containing sample even when diluted with poly(vinyl acetate) homopolymer.

### EXAMPLE2

In the experiments set forth in Example 1, it was found that the addition of epoxy (along with contained amine crosslinker) to AIRFLEX 809 VAE emulsions yielded dramatic improvements in wet adhesion for a specific semi-gloss paint formulation. Additional studies were conducted to determine the effect of epoxy level on the wet adhesion. The results are listed in Tables 2 and 3.

The epoxy level listed includes Epon 828 epoxy resin and the amine crosslinker-IPDA. Listed in Table 3 are the results for FLEXBOND® 325 vinyl acrylic polymer emulsion/epoxy combinations showing the improved wet adhesion with decreased gloss.

TABLE 2

| | | AIRFLEX | AIRFLEX | AIRFLEX | AIRFLEX |
|---|---|---|---|---|---|
| | | 809 VAE | 809 VAE | 809 VAE | 809 VAE |
| | AIRFLEX 809 | polymer/ | polymer/ | polymer/ | polymer/ |
| Blend | VAE polymer | Epoxy | Epoxy | Epoxy | Epoxy |
| Ratio (by wt. solids) | 100 | 93/7 | 86/14 | 79/21 | 76.5/23.5 |
| Viscosity: 24 hr KU | 91 | 95 | 94 | 94 | 97 |
| 20 Gloss | 12.3 | 7.9 | 5.8 | 4.4 | 3.9 |
| 60 Gloss | 55.4 | 49.5 | 42.6 | 38.9 | 32.1 |
| Reflectance | 93.6 | 94.5 | 95 | 94.6 | 94.4 |
| Contrast Ratio | 0.98 | 0.98 | 0.974 | 0.982 | 0.982 |
| Freeze/Thaw (# | fail(1) | fail(1) | fail (1) | fail(1) | fail(1) |
| cycles) | | | | | |
| Reflectance/Black | 91.7 | 92.6 | 92.5 | 92.9 | 92.7 |
| Scrub | 61,075 | >56,000 | 26,760 | 12,085 | 4375 |
| resistance(cycles) | | | | | |
| Blocking | | | | | |
| Dry time 1.5 hr; 100 g | 2,2,1 | 0,0,0 | 3,3,3 | 3,3,3 | 7,6,7 |
| Dry time 1.5 hr; 500 g | 0,0,0 | 0,0,0 | 0,0,0 | 1,0,0 | 5,5,5 |
| ASTM METHOD (1 | | | | | |
| kg) | | | | | |
| Dry time; 1 hr | 0,0,0 | 0,0,0 | 0,0,0 | 3,3,2 | 3,3,3 |
| Dry time: 4 hrs. | 0,0,0 | 0,0,0 | 0,0,0 | 0,0,0 | 3,3,3 |
| Dry time: 24 hrs | 0,0,0 | 0,0,0 | 0,0,0 | 0,0,0 | 3,3,3 |
| Wet Adhesion | 0% | 83% | 98% | 100% | 100% |

Stoichiometric addition of isophoronediamine based on included epoxy.

TABLE 3

| | | FLEXBOND | |
|---|---|---|---|
| | AIRFLEX 809 | 325 | |
| | VAE | vinyl | FLEXBOND 325 |
| | polymer/VINAC | acrylic | vinyl acrylic |
| Blend | 884 PVAc/Epoxy | polymer | polymer/Epoxy |
| Ratio (by wt. | 61/19/20 | 100 | 86/14 |
| solids) | | | |
| Viscosity: | 99 | 91 | 96 |
| 24 hr KU | | | |
| 20 Gloss | 5.5 | 18.6 | 3.7 |
| 60 Gloss | 37.9 | 61.1 | 31 |
| Reflectance | 94.3 | 94.4 | 94.8 |
| Contrast Ratio | 0.983 | 0.977 | 0.98 |
| Freeze/Thaw | | pass | fail(3) |
| (# cycles) | | | |
| Reflectance/ | 92.7 | 92.2 | 92.9 |
| Black | | | |
| Scrub | 3,298 | 2685 | 1,725 |
| resistance | | | |
| (cycles) | | | |
| Blocking | | | |
| Dry time 1.5 | 7, 7, 8 | 7, 7, 7 | 8, 8, 8 |
| hr; 100 g | | | |
| Dry time 1.5 | 7, 7, 7 | 6, 3, 6 | 6, 7, 7 |
| hr; 500 g | | | |
| ASTM METHOD | | | |
| (1 kg) | | | |
| Dry time; | 7, 7, 7 | 8, 8, 7 | 7, 7, 7 |
| 1 hr | | | |
| Dry time: | 6, 5, 5 | 1, 5, 3 | 5, 6, 5 |
| 4 hrs. | | | |
| Dry time: | 3, 3, 3 | 0, 0, 0 | 3, 3, 3 |
| 24 hrs | | | |
| Wet Adhesion | 100% | 0% | 100% |

Stoichiometric addition of isophoronediamine based on included epoxy.

As shown in Table 2, the improvement in wet adhesion occurs at quite modest epoxy addition levels, e.g., 14% by weight. AIRFLEX 809 VAE polymer, on the other hand, without the epoxy resin, exhibited poor wet adhesion. Table 2 shows a loss in gloss is obtained with significant improvements in block resistance observed at higher epoxy levels.

The results in Table 3 show that partial substitution of AIRFLEX 809 VAE polymer with VINAC 884 poly(vinyl acetate) allows for improved block resistance. The scrub resistance is decreased with the addition of epoxy, however, still retains quite respectable values. Some problem with grit formation was observed at higher epoxy levels and also in the AIRFLEX 809 VAE polymer/VINAC 884 poly(vinyl acetate) systems. Adjustment of pH may correct this problem as the residual amine could interfere with dispersants which are characteristically added in paint formulations.

### EXAMPLE 3

### EFFECT OF LEVEL OF THE EPOXY/AMINE ADDITIVE AND AMINE CHOICE

This example looks at the stoichiometric level of the epoxy/amine additive, the amine choice, and the effect of individual constituents. The results are listed in Table 4. The samples were prepared with the same procedure as noted above for semi-gloss evaluation. In these experiments only the wet adhesion results were obtained.

TABLE 4

| | Wet Adhesion, |
|---|---|
| Sample | % |
| AIRFLEX 809 VAE polymer Control | 0 |
| AIRFLEX 809 VAE polymer + 10 wt % epoxy | 0 |
| (solids basis) | |
| AIRFLEX 809 VAE polymer + IPDA | 0 |
| (2.43% solids basis) | |
| AIRFLEX 809 VAE polymer + 10 wt % epoxy + | 100 |
| IPDA (stoichiometric addition: (1/1)) | |
| AIRFLEX 809 VAE polymer + 10 wt % epoxy + | 100 |
| IPDA (epoxy/IPDA: 1.5/1) | |
| AIRFLEX 809 VAE polymer + 10 wt % epoxy + | 100 |
| IPDA (epoxy/IPDA: 0.67/1) | |
| AIRFLEX 809 VAE polymer + 10 wt % epoxy + | 100 |
| Jeffamine D-230 (stoichiometric addition (1/1)) | |
| AIRFLEX 809 VAE polymer + 10 wt % epoxy + | 100 |
| TETA (stoichiometric addition: 1/1)) | |
| AIFRLEX 809 VAE polymer + 5 wt % epoxy + | 95 |
| IPDA (stoichiometric addition: (1/1)) | |
| AIRFLEX 809 VAE polymer + 5 wt % epoxy + | 44 |
| IPDA (epoxy/IPDA: 1.5/1) | |
| AIRFLEX 809 VAE polymer + 5 wt % epoxy + | 0 |
| IPDA (epoxy/IPDA: 0.67/1) | |
| AIRFLEX 728 VAE polymer Control | 0 |
| AIRFLEX 728 VAE polymer + 10 wt % epoxy + | 100 |
| IPDA (stoichiometric addition: (1/1)) | |

TETA = triethylene tetraamine
Jeffamine D-230 = diamine of an oligomeric poly(propylene oxide) supplied by Jefferson Chemical

### EXAMPLE 4

### EFFECT OF EMULSION TYPE

This example involves the preparation of three different emulsions containing epoxy (Epon 828 epoxy) at a level of 10 wt % solids based on emulsion solids and with a stoichiometric addition of isophoronediamine (IPDA). The three emulsions were: AIRFLEX-728 VAE polymer, FLEXBOND-325 vinyl acrylic polymer and a 60/40 (by wt solids) blend of AIRFLEX-809 VAE polymer/VINAC-884 PVAc. The semi-gloss paint was made as noted for the above samples and the test panels for wet adhesion were coated after one day, three days, seven days and one month storage to determine if changes in wet adhesion occurred. The results are listed in Table 5.

TABLE 5

| | | Control | | | 60/40 |
|---|---|---|---|---|---|
| | Control | FLEXBOND- | | FLEXBOND- | AIRFLEX-809 |
| | AIRFLEX- | 325 vinyl | AIRFLEX- | 325 vinyl | VAE |
| | 728 VAE | acrylic | 728 VAE | acrylic | polymer/VINAC- |
| Time | polymer | polymer | polymer* | polymer* | 884 PVAc |
| 1 day | 0% | 0% | 100% | 100% | 100% |
| 7 days | | | 100% | 94% | 100% |
| 1 month | | | 100% | 100% | 100% |

*Contains 10 wt % epoxy + stoichiometric IPDA

The samples containing 10 wt % epoxy were diluted with the base emulsion system to yield an epoxy level of 5 wt % epoxy based on solids+stoichiometric IPDA. The protocol for the above set of experiments was repeated. The wet adhesion results are listed in Table 6.

TABLE 6

| | | FLEXBOND- | |
|---|---|---|---|
| | | 325 vinyl | |
| | AIRFLEX-728 | acrylic | 60/40 AIRFLEX-809 |
| Time | VAE polymer* | polymer* | VAE/VINAC-884 PVAc* |
| 3 days | 56% | 56% | 100% |
| 7 days | 94% | 52% | 100% |
| 1 month | 50-97% | 86% | 100% |

*Contains 5 wt % epoxy + stoichiometric IPDA

A description of the emulsions employed in the above examples is given below: AIRFLEX 809 vinyl acetate polymer emulsion has a T_{g}=2° C.; particle size of 0.19μ; solids content of 55%; available from Air Products and Chemicals, Inc. FLEXBOND 325 vinyl acrylic polymer emulsion (vinyl acetate/n-butyl acrylate) has a T_{g}=19° C.; particle size =0.30μ; solids content =55%; available from Air Products and Chemicals, Inc.

AIRFLEX 728 vinyl acetate/ethylene/vinyl chloride polymer has a T_{g}=0°C.; particle size =0.17μ; solids content =52%; available from Air Products and Chemicals, Inc. VINAC 884 poly(vinyl acetate) polymer emulsion has a T_{g}=35° C.; particle size =0.17μ; solids content =50%; available from Air Products and Chemicals, Inc

1. In a water-based paint suited for interior and exterior application comprised of a pigment grind and a polymeric emulsion selected from the group consisting of a vinyl acetate based polymeric emulsion, a acrylic based polymeric emulsion, and a styrene/acrylate based polymeric emulsion, the improvement for enhancing wet adhesion of said water based paint which comprises:
incorporating an epoxy resin and amine curative into said water-based paint.

2. The water-based paint of claim 1 wherein the polymeric emulsion is formed by emulsion polymerization.

3. The water-based paint of claim 2 wherein the polymeric emulsion is a vinyl acetate based polymeric emulsion.

4. The water-based paint of claim 3 wherein the vinyl acetate based polymeric emulsion is comprised of vinyl acetate and ethylene.

5. The water-based paint of claim 4 wherein the epoxy resin is a glycidyl ether of bisphenol A.

6. The water-based paint of claim 5 wherein the epoxy resin is incorporated in an amount of from 2 to 25% by weight of the solids content of the polymeric emulsion.

7. The water-based paint of claim 5 wherein the amine curative is selected from the group consisting of a polyalkylene amine selected from the group consisting of diethylenetriamine and triethylenetetraamine, isophoronediamine, a diamine of oligomeric poly(propylene oxide), 2-methyl-1,5-pentanediamine, a polyamide polyamine, a polycycloaliphatic amine, dimethylenedi(cyclohexylamine), aminoethylpiperazine, and xylylenediamine.

8. The water-based paint of claim 7 wherein the amine is isophoronediamine.

9. In a surface coated with a first paint composition, the improvement which comprises a water-based paint composition of claim 1 applied thereto.

10. The surface of claim 10 wherein the polymer emulsion is a vinyl acetate based polymer emulsion.

11. The surface of claim 10 wherein the vinyl acetate based polymeric emulsion is comprised of vinyl acetate and ethylene.

12. The surface of claim 10 wherein the epoxy resin is a glycidyl ether of bisphenol A.

13. The surface of claim 12 wherein the epoxy resin is incorporated in an amount of from 2 to 25% by weight of the solids content of the polymeric emulsion.

14. The surface of claim 12 wherein the amine curative is selected from the group consisting of a polyalkylene amine selected from the group consisting of diethylenetriamine and triethylenetetraamine, isophoronediamine, a diamine of oligomeric poly(propylene oxide), 2-methyl-1,5-pentanediamine, a polyamide polyamine, a polycycloaliphatic amine, dimethylenedi(cyclohexylamine), aminoethylpiperazine, and xylylenediamine.

15. The surface of claim 14 wherein the amine is isophoronediamine.
